(19) United States
(12) Patent Application Publication
(10) Pub. No.: US 2005/0168006 A1
(43) Pub. Date: Aug. 4, 2005

(54) Stroller sun screen

(76) Inventor: Rodney Darland, Mission Viejo, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/767,853

(22) Filed: Jan. 29, 2004

(51) Int. Cl. B60J 3/00

(52) U.S. Cl. 296/97.21

(57) ABSTRACT

Herein disclosed is a Stroller Sun Screen with an elliptical screen portion, a spring steel band frame, a sewn binding that traps the band frame so that it surrounds the screen portion and encloses the band portion, a pair of hook and loop fastening strips, the binding sewn onto the screen portion, and the hook and loop fastening strips each sewn to the left and right side of the binding. A preferred embodiment includes the hook and loop fastening strips attach to the left and right frame members of a standard baby stroller thereby fastening the sun screen to the normally open portion of the baby stroller thereby enclosing most of the area between the left and right frame members and the leading edge of the canopy of the stroller, thereby creating shade for the occupant of the stroller even when the sun is at a low angle.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of sun screens and more specifically to a stroller sun screen.

Baby strollers are well known. They consist of a plurality of wheels, a seat portion a frame that supports the seat and and a top canopy that can be adjusted to cover more or less of the top of the stroller. The frame includes a handle portion so that a care giver can comfortably push the stroller and its occupant along a flat surface such as a sidewalk or the like.

The canopy portion of a standard baby stroller can help protect the occupant's face from direct exposure to the sun. However the standard stroller canopy can not fully protect the occupant from exposure to the sun when it is at a low angle, thereby causing discomfort to the occupant.

Therefore there is a need for an additional sun screen for times when the sun is at a low angle in the sky.

### BRIEF SUMMARY OF THE INVENTION

The primary object of the invention is to provide a sun screen for a stroller that is easy to attach to a standard stroller.

Another object of the invention is to provide a sun screen for a stroller that provides a complete sun protection for the occupant of a stroller.

Another object of the invention is to provide a sun screen that folds for compact storage in a fitted carry bag.

A further object of the invention is to provide a sun screen that maintains its shape when in use.

Yet another object of the invention is to provide a sun screen that is easy and inexpensive to manufacture.

Still yet another object of the invention is to provide a sun screen that can be rotated to a high position to provide partial sun protection.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Stroller Sun Screen comprising: an elliptical screen portion, a spring steel band frame, a sewn binding that traps said band frame so that it surrounds said screen portion and encloses said band portion, a pair of hook and loop fastening strips, said binding sewn onto said screen portion, and said hook and loop fastening strips each sewn to the left and right side of said binding.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention. with the sun screen in place in its full use position.

FIG. 2 is a plan view of the invention in its open state

FIG. 3 is a perspective view of the invention with the sun screen in the raised position.

FIG. 4 is a plan view of the invention in its collapsed state

FIG. 5 is a exploded view of the invention and its carry bag

FIG. 6 is a side section view of the invention

FIG. 7 is a view of the invention in its twisted position on its way to being collapsed.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

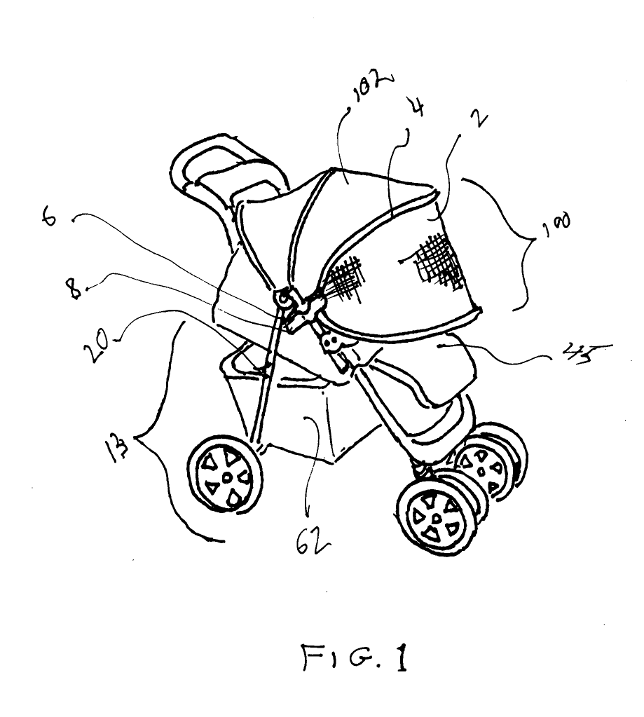

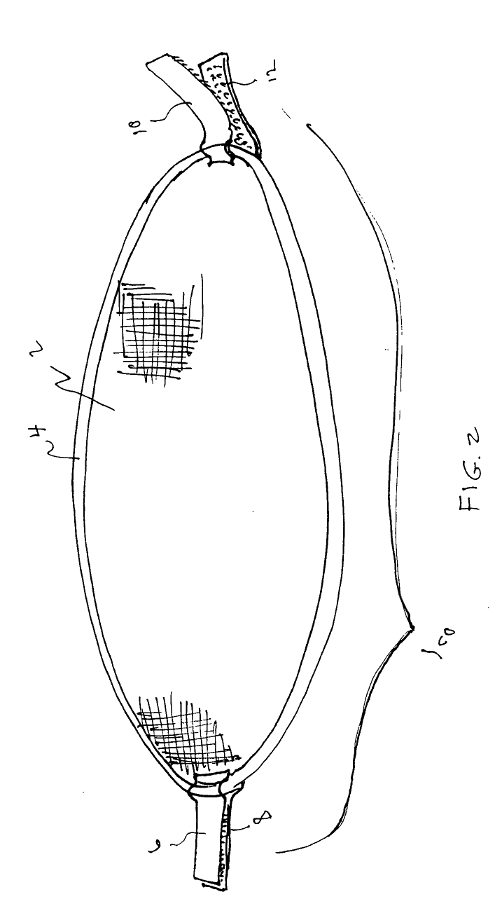

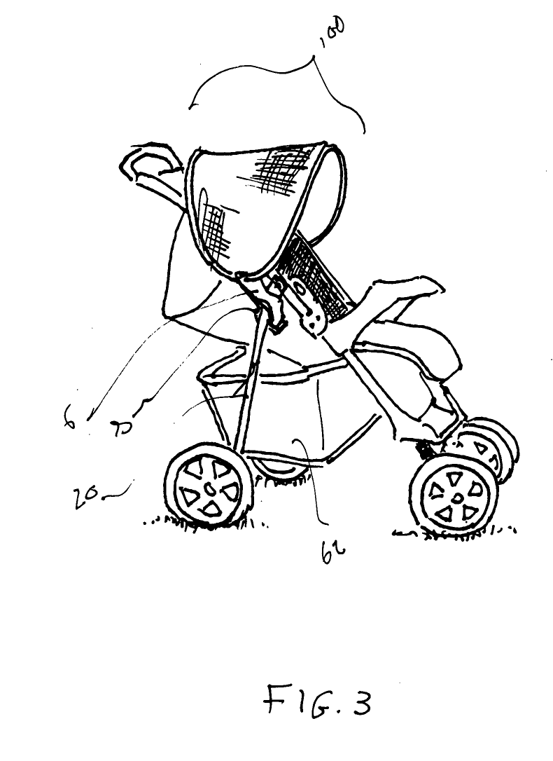

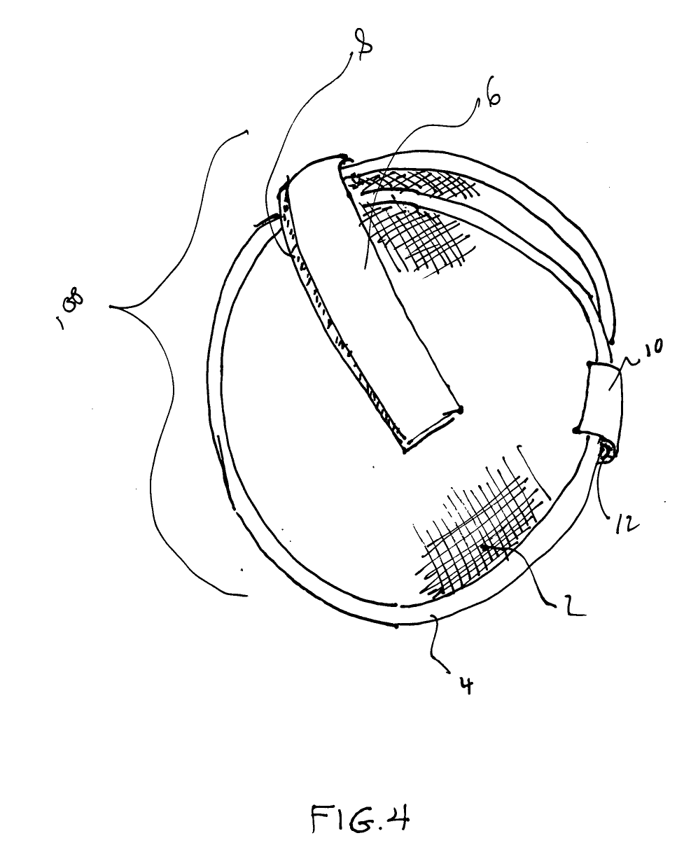

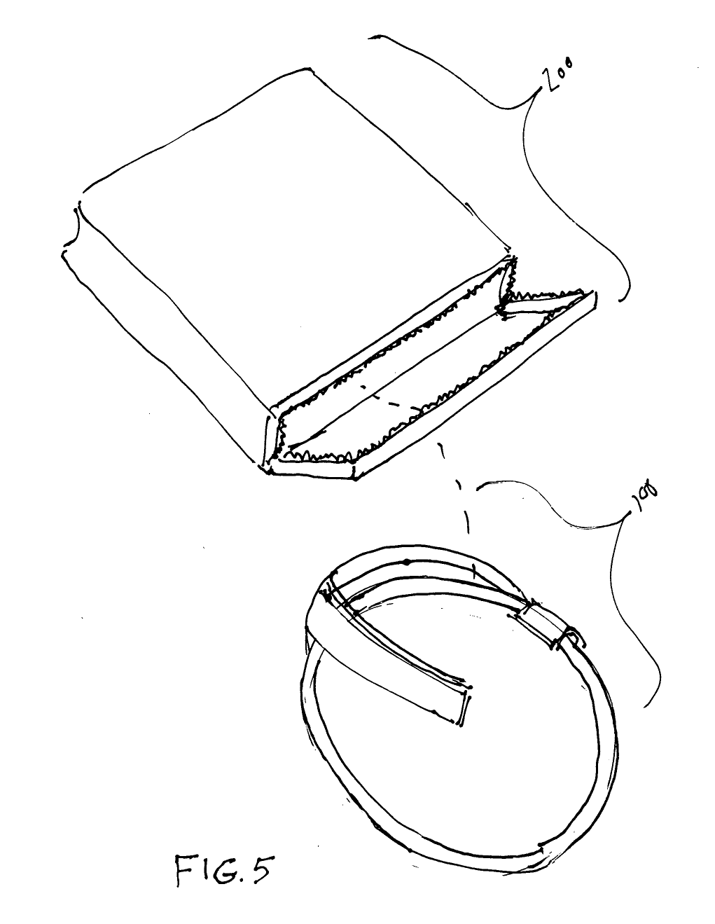

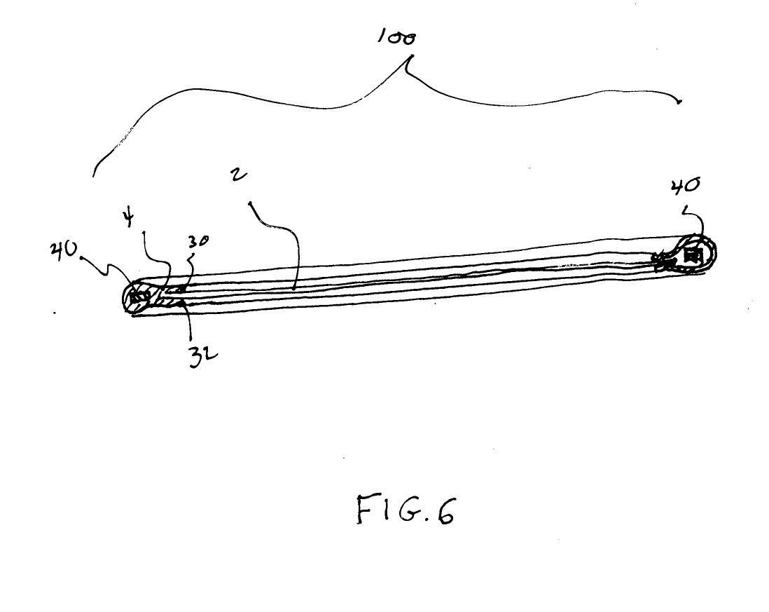

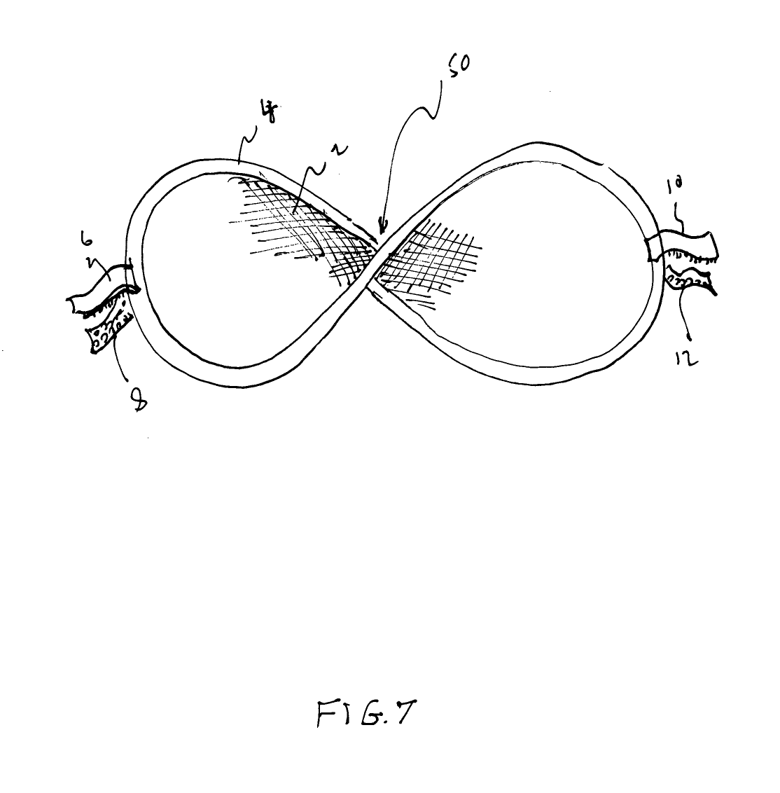

Referring now to FIG. 1 we see a perspective view of the invention 100 shown attached to a standard baby stroller 13. The invention 100 is comprised of a flexible screen portion 2, a frame portion comprised of a cloth binding strip 4 and an internal spring steel band 40 shown in section view in FIG. 6 and two pairs of hook and loop fastening strips 6, 8, 10, 12. The fastening strips 6, 8, 10, 12 are sewn to each end of the frame 4 as shown in FIG. 2. The screen 2 and frame 4 form an elongated ellipse approximately—long and—inches wide. The screen 2 is made of flexible polyester plastic or other standard flexible screening material. The hook and loop fastening strips 6, 8, 10, 12 are approximately two inches wide and six inches long. Each strip is sewn on one end to binding cloth 4. Screen 2 is sewn between the lips 30, 32 of binding portion 4 as shown in FIG. 6. The strips 6, 8, 10, 12 are used to removably attach the frame 4 and enclosed screen 2 to the stroller frame 20 of a standard stroller 13 as shown in FIG. 1. The shape of screen 2 and frame 4 is such that the top edge of frame 4 makes intimate contact with the leading edge of canopy 102 so that the screen 2 can protect the occupant of the stroller 13 from the uncomfortable and potentially damaging effects of full exposure to low angled sun. The spring nature of internal band 40 allows the frame 4 to flex to fit most standard contemporary strollers. The spring nature of the band 40 also allows the frame 4 to twist as shown in FIG. 7 and fold as shown in FIG. 4 so that it is approximately one quarter of its open flat size and can fit into a carry bag 200 as shown in FIG. 5 and stored in the carry portion 62 of a standard stroller 13. The invention 100 protects the occupant's face and torso from full exposure to the sun but allows the occupants legs and feet to extend between the space created by the lower edge of frame 4 and stroller seat pad 45. The hook and loop fastening strips 6, 8, 10, 12 also can act as a pivot joint so that the invention 100 can be rotated up as shown in FIG. 3 to allow the occupant of the stroller to see in an unobstructed fashion while still being protected from overhead sun. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A Stroller Sun Screen comprising:
an elliptical screen portion;
a spring steel band frame;
a sewn binding that traps said band frame so that it surrounds said screen portion and encloses said band portion;
a pair of hook and loop fastening strips;
said binding sewn onto said screen portion; and
said hook and loop fastening strips each sewn to the left and right side of said binding.

2. A Stroller Sun Screen as claimed in claim 1 wherein said hook and loop fastening strips are positioned such that they are capable of being attached to the left and right frame members of a standard baby stroller, respectively, thereby fastening said sun screen to the normally open portion of said baby stroller thereby enclosing most of the area between said left and right frame members and the leading edge of the canopy of said stroller, thereby creating shade for the occupant of the stroller even when the sun is at a low angle.

3. A Stroller Sun Screen as claimed in claim 1 wherein said spring steel band is capable of being twisted so that the entire sun screen of the present invention can be collapsed into a circular shape that is approximately one quarter the size of the fully opened sun screen.

4. A Stroller Sun Screen as claimed in claim 1 wherein said screening portion is comprised of a fine mesh polyester material.

5. A Stroller Sun Screen as claimed in claim 1 further comprising a carry bag that can removably retain said sun screen when in its collapsed position.

6. A Stroller Sun Screen as claimed in claim 1 wherein said hook and loop strips are positioned such that they are capable of acting as pivot points enabling said sun screen to be upwardly rotatable so that said screen is parallel to the ground, thus enabling the occupant of the stroller to see in an unencumbered way and yet remain protected from the full rays of the overhead sun.

7. A Stroller Sun Screen as claimed in claim 1 wherein said frame and enclosed screen are of a sufficient width to extend from one side frame member of a standard baby carriage to the opposite side frame member thereof.

8. A Stroller Sun Screen as claimed in claim 1 wherein said hook and loop fastening strips are approximately two inches wide and six inches long.
